(19) United States
(12) Patent Application Publication
(10) Pub. No.: US 2020/0328660 A1
(43) Pub. Date: Oct. 15, 2020

(54) METHOD AND SYSTEM TO ACHIEVE FULLY REDUNDANT FAIL-SAFE SWITCH OFF PATHS FOR INVERTER SYSTEM

(71) Applicant: NIO USA, Inc., San Jose, CA (US)

(72) Inventors: Bo Guo, San Jose, CA (US); He Li, San Jose, CA (US); Miaosen Shen, Fremont, CA (US); Yu Liu, San Jose, CA (US)

(21) Appl. No.: 16/384,479

(22) Filed: Apr. 15, 2019

(51) Int. Cl. H02K 11/33; H02K 7/00; B60L 3/00

(52) U.S. Cl. CPC H02K 11/33; H02K 7/006; B60K 6/22; H02K 2213/06; B60L 2210/44; B60L 3/0092

(57) ABSTRACT

Embodiments of the present disclosure comprise fully redundant inverter safety switch off paths for inverter system fail safe/fail operational control of electrical drive systems in an electric vehicle. A safety switch according to embodiments described herein provides independent, redundant paths, for example, to high side and low side switches, to shut off electric motor output torque and ensure the safety state is achieved. An inverter safety switch as described herein can comprise a logic circuit including two AND gate and one two-way switch on each independent and redundant path. This design can be cost effective compared to current state of art designs using programable CPLDs or FPGAs and does not need to be programmed for each inverter. Additionally, such independent and redundant paths can eliminate the common cause or cascaded failures that can occur in prior safety switch designs.

### FIELD

The present disclosure is generally directed to electric and/or hybrid-electric vehicles more particularly to a fail-safe inverter safety switch with independent and redundant paths.

### BACKGROUND

In an electric vehicle, an electrical inverter is used to convert the DC current from a high voltage battery to AC current to drive the vehicle propulsion system. The inverter also plays a significant role in capturing energy from regenerative braking and provide it back to charge the high voltage battery. The inverter output current directly impacts vehicle acceleration/deceleration and stability, i.e., with torque vectoring. Therefore, the inverter is a safety related electrical system. Following the safety standard ISO 26262, it is safety critical to shut off the inverter output in time before a catastrophic failure and maintain it in the safe state when an inverter system malfunction is detected. Current systems to address these requirements utilize safety switches with Complex Programmable Logic Device (CPLD) or Field Programmable Gate Array (FPGA) controllers. However, such systems are complex, and therefore expensive, and are prone to common cause or cascaded failures. Hence, there is a need in the art for improved fail-safe inverter safety switches with fully independent and redundant paths through simplified circuit designs.

### BRIEF DESCRIPTION OF THE DRAWINGS

FIG. 1 shows a vehicle in accordance with embodiments of the present disclosure.

FIG. 2 shows a plan view of the vehicle in accordance with at least some embodiments of the present disclosure.

FIG. 3 shows a plan view of the vehicle in accordance with embodiments of the present disclosure.

FIG. 4 is a block diagram illustrating additional details of an electrical system of the vehicle according to one embodiment of the present disclosure.

FIG. 5 is a block diagram illustrating redundant fail-safe paths of an inverter safety switch according to one embodiment of the present disclosure.

FIG. 6 is a schematic diagram of inverter safety switch circuits according to one embodiment of the present disclosure.

FIG. 7 is a flowchart illustrating an exemplary process for operating an inverter safety switch according to one embodiment of the present disclosure.

FIG. 8 is a flowchart illustrating an exemplary process for normal operations of an inverter safety switch according to one embodiment of the present disclosure.

FIG. 9 is a flowchart illustrating an exemplary process for safety chip fault handling in an inverter safety switch according to one embodiment of the present disclosure.

FIG. 10 is a flowchart illustrating an exemplary process for latent fault handling in an inverter safety switch according to one embodiment of the present disclosure.

### DETAILED DESCRIPTION

Embodiments of the present disclosure will be described in connection with a vehicle, and in some embodiments, an electric vehicle, rechargeable electric vehicle, and/or hybrid-electric vehicle and associated systems.

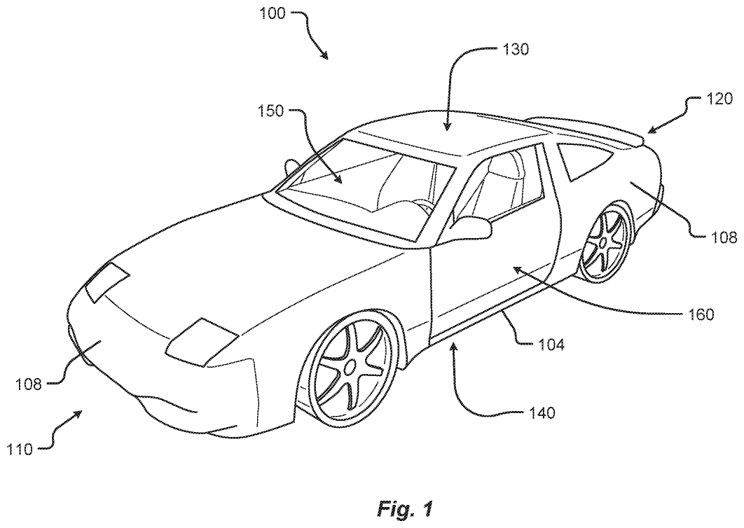

FIG. 1 shows a perspective view of a vehicle 100 in accordance with embodiments of the present disclosure. The electric vehicle 100 comprises a vehicle front 110, vehicle aft 120, vehicle roof 130, at least one vehicle side 160, a vehicle undercarriage 140, and a vehicle interior 150. In any event, the vehicle 100 may include a frame 104 and one or more body panels 108 mounted or affixed thereto. The vehicle 100 may include one or more interior components (e.g., components inside an interior space 150, or user space, of a vehicle 100, etc.), exterior components (e.g., components outside of the interior space 150, or user space, of a vehicle 100, etc.), drive systems, controls systems, structural components, etc.

Although shown in the form of a car, it should be appreciated that the vehicle 100 described herein may include any conveyance or model of a conveyance, where the conveyance was designed for the purpose of moving one or more tangible objects, such as people, animals, cargo, and the like. The term “vehicle” does not require that a conveyance moves or is capable of movement. Typical vehicles may include but are in no way limited to cars, trucks, motorcycles, busses, automobiles, trains, railed conveyances, boats, ships, marine conveyances, submarine conveyances, airplanes, space craft, flying machines, human-powered conveyances, and the like.

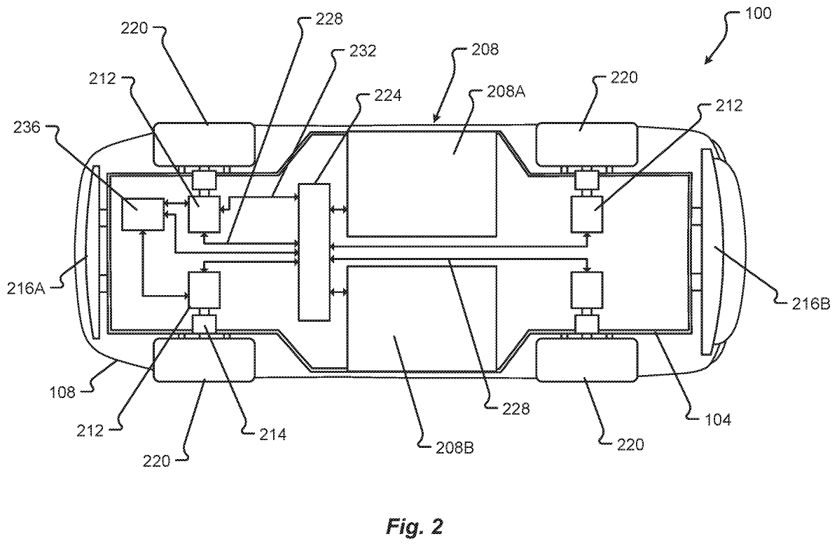

Referring now to FIG. 2, a plan view of a vehicle 100 will be described in accordance with embodiments of the present disclosure. As provided above, the vehicle 100 may comprise a number of electrical and/or mechanical systems, subsystems, etc. The mechanical systems of the vehicle 100 can include structural, power, safety, and communications subsystems, to name a few. While each subsystem may be described separately, it should be appreciated that the components of a particular subsystem may be shared between one or more other subsystems of the vehicle 100.

The structural subsystem includes the frame 104 of the vehicle 100. The frame 104 may comprise a separate frame and body construction (i.e., body-on-frame construction), a unitary frame and body construction (i.e., a unibody construction), or any other construction defining the structure of the vehicle 100. The frame 104 may be made from one or more materials including, but in no way limited to steel, titanium, aluminum, carbon fiber, plastic, polymers, etc., and/or combinations thereof. In some embodiments, the frame 104 may be formed, welded, fused, fastened, pressed, etc., combinations thereof, or otherwise shaped to define a physical structure and strength of the vehicle 100. In any event, the frame 104 may comprise one or more surfaces, connections, protrusions, cavities, mounting points, tabs, slots, or other features that are configured to receive other components that make up the vehicle 100. For example, the body panels 108, powertrain subsystem, controls systems, interior components, communications subsystem, and safety subsystem may interconnect with, or attach to, the frame 104 of the vehicle 100.

The frame 104 may include one or more modular system and/or subsystem connection mechanisms. These mechanisms may include features that are configured to provide a selectively interchangeable interface for one or more of the systems and/or subsystems described herein. The mechanisms may provide for a quick exchange, or swapping, of components while providing enhanced security and adaptability over conventional manufacturing or attachment. For instance, the ability to selectively interchange systems and/or subsystems in the vehicle 100 allow the vehicle 100 to adapt to the ever-changing technological demands of society and advances in safety. Among other things, the mechanisms may provide for the quick exchange of batteries, capacitors, power sources 208A, 208B, motors 212, engines, safety equipment, controllers, user interfaces, interiors exterior components, body panels 108, bumpers 216, sensors, etc., and/or combinations thereof. Additionally or alternatively, the mechanisms may provide unique security hardware and/or software embedded therein that, among other things, can prevent fraudulent or low quality construction replacements from being used in the vehicle 100. Similarly, the mechanisms, subsystems, and/or receiving features in the vehicle 100 may employ poka-yoke, or mistake-proofing, features that ensure a particular mechanism is always interconnected with the vehicle 100 in a correct position, function, etc.

By way of example, complete systems or subsystems may be removed and/or replaced from a vehicle 100 utilizing a single-minute exchange (“SME”) principle. In some embodiments, the frame 104 may include slides, receptacles, cavities, protrusions, and/or a number of other features that allow for quick exchange of system components. In one embodiment, the frame 104 may include tray or ledge features, mechanical interconnection features, locking mechanisms, retaining mechanisms, etc., and/or combinations thereof. In some embodiments, it may be beneficial to quickly remove a used power source 208A, 208B (e.g., battery unit, capacitor unit, etc.) from the vehicle 100 and replace the used power source 208A, 208B with a charged or new power source. Continuing this example, the power source 208A, 208B may include selectively interchangeable features that interconnect with the frame 104 or other portion of the vehicle 100. For instance, in a power source 208A, 208B replacement, the quick release features may be configured to release the power source 208A, 208B from an engaged position and slide or move in a direction away from the frame 104 of a vehicle 100. Once removed, or separated from, the vehicle, the power source 208A, 208B may be replaced (e.g., with a new power source, a charged power source, etc.) by engaging the replacement power source into a system receiving position adjacent to the vehicle 100. In some embodiments, the vehicle 100 may include one or more actuators configured to position, lift, slide, or otherwise engage the replacement power source with the vehicle 100. In one embodiment, the replacement power source may be inserted into the vehicle 100 or vehicle frame 104 with mechanisms and/or machines that are external and/or separate from the vehicle 100.

In some embodiments, the frame 104 may include one or more features configured to selectively interconnect with other vehicles and/or portions of vehicles. These selectively interconnecting features can allow for one or more vehicles to selectively couple together and decouple for a variety of purposes. For example, it is an aspect of the present disclosure that a number of vehicles may be selectively coupled together to share energy, increase power output, provide security, decrease power consumption, provide towing services, and/or provide a range of other benefits. Continuing this example, the vehicles may be coupled together based on travel route, destination, preferences, settings, sensor information, and/or some other data. The coupling may be initiated by at least one controller of the vehicle and/or traffic control system upon determining that a coupling is beneficial to one or more vehicles in a group of vehicles or a traffic system. As can be appreciated, the power consumption for a group of vehicles traveling in a same direction may be reduced or decreased by removing any aerodynamic separation between vehicles. In this case, the vehicles may be coupled together to subject only the foremost vehicle in the coupling to air and/or wind resistance during travel. In one embodiment, the power output by the group of vehicles may be proportionally or selectively controlled to provide a specific output from each of the one or more of the vehicles in the group.

The interconnecting, or coupling, features may be configured as electromagnetic mechanisms, mechanical couplings, electromechanical coupling mechanisms, etc., and/or combinations thereof. The features may be selectively deployed from a portion of the frame 104 and/or body of the vehicle 100. In some cases, the features may be built into the frame 104 and/or body of the vehicle 100. In any event, the features may deploy from an unexposed position to an exposed position or may be configured to selectively engage/disengage without requiring an exposure or deployment of the mechanism from the frame 104 and/or body of the vehicle 100. In some embodiments, the interconnecting features may be configured to interconnect one or more of power, communications, electrical energy, fuel, and/or the like. One or more of the power, mechanical, and/or communications connections between vehicles may be part of a single interconnection mechanism. In some embodiments, the interconnection mechanism may include multiple connection mechanisms. In any event, the single interconnection mechanism or the interconnection mechanism may employ the poka-yoke features as described above.

The power system of the vehicle 100 may include the powertrain, power distribution system, accessory power system, and/or any other components that store power, provide power, convert power, and/or distribute power to one or more portions of the vehicle 100. The powertrain may include the one or more electric motors 212 of the vehicle 100. The electric motors 212 are configured to convert electrical energy provided by a power source into mechanical energy. This mechanical energy may be in the form of a rotational or other output force that is configured to propel or otherwise provide a motive force for the vehicle 100.

In some embodiments, the vehicle 100 may include one or more drive wheels 220 that are driven by the one or more electric motors 212 and motor controllers 214. In some cases, the vehicle 100 may include an electric motor 212 configured to provide a driving force for each drive wheel 220. In other cases, a single electric motor 212 may be configured to share an output force between two or more drive wheels 220 via one or more power transmission components. It is an aspect of the present disclosure that the powertrain may include one or more power transmission components, motor controllers 214, and/or power controllers that can provide a controlled output of power to one or more of the drive wheels 220 of the vehicle 100. The power transmission components, power controllers, or motor controllers 214 may be controlled by at least one other vehicle controller or computer system as described herein.

As provided above, the powertrain of the vehicle 100 may include one or more power sources 208A, 208B. These one or more power sources 208A, 208B may be configured to provide drive power, system and/or subsystem power, accessory power, etc. While described herein as a single power source 208 for sake of clarity, embodiments of the present disclosure are not so limited. For example, it should be appreciated that independent, different, or separate power sources 208A, 208B may provide power to various systems of the vehicle 100. For instance, a drive power source may be configured to provide the power for the one or more electric motors 212 of the vehicle 100, while a system power source may be configured to provide the power for one or more other systems and/or subsystems of the vehicle 100. Other power sources may include an accessory power source, a backup power source, a critical system power source, and/or other separate power sources. Separating the power sources 208A, 208B in this manner may provide a number of benefits over conventional vehicle systems. For example, separating the power sources 208A, 208B allow one power source 208 to be removed and/or replaced independently without requiring that power be removed from all systems and/or subsystems of the vehicle 100 during a power source 208 removal/replacement. For instance, one or more of the accessories, communications, safety equipment, and/or backup power systems, etc., may be maintained even when a particular power source 208A, 208B is depleted, removed, or becomes otherwise inoperable.

In some embodiments, the drive power source may be separated into two or more cells, units, sources, and/or systems. By way of example, a vehicle 100 may include a first drive power source 208A and a second drive power source 208B. The first drive power source 208A may be operated independently from or in conjunction with the second drive power source 208B and vice versa. Continuing this example, the first drive power source 208A may be removed from a vehicle while a second drive power source 208B can be maintained in the vehicle 100 to provide drive power. This approach allows the vehicle 100 to significantly reduce weight (e.g., of the first drive power source 208A, etc.) and improve power consumption, even if only for a temporary period of time. In some cases, a vehicle 100 running low on power may automatically determine that pulling over to a rest area, emergency lane, and removing, or “dropping off,” at least one power source 208A, 208B may reduce enough weight of the vehicle 100 to allow the vehicle 100 to navigate to the closest power source replacement and/or charging area. In some embodiments, the removed, or “dropped off,” power source 208A may be collected by a collection service, vehicle mechanic, tow truck, or even another vehicle or individual.

The power source 208 may include a GPS or other geographical location system that may be configured to emit a location signal to one or more receiving entities. For instance, the signal may be broadcast or targeted to a specific receiving party. Additionally or alternatively, the power source 208 may include a unique identifier that may be used to associate the power source 208 with a particular vehicle 100 or vehicle user. This unique identifier may allow an efficient recovery of the power source 208 dropped off. In some embodiments, the unique identifier may provide information for the particular vehicle 100 or vehicle user to be billed or charged with a cost of recovery for the power source 208.

The power source 208 may include a charge controller 224 that may be configured to determine charge levels of the power source 208, control a rate at which charge is drawn from the power source 208, control a rate at which charge is added to the power source 208, and/or monitor a health of the power source 208 (e.g., one or more cells, portions, etc.). In some embodiments, the charge controller 224 or the power source 208 may include a communication interface. The communication interface can allow the charge controller 224 to report a state of the power source 208 to one or more other controllers of the vehicle 100 or even communicate with a communication device separate and/or apart from the vehicle 100. Additionally or alternatively, the communication interface may be configured to receive instructions (e.g., control instructions, charge instructions, communication instructions, etc.) from one or more other controllers or computers of the vehicle 100 or a communication device that is separate and/or apart from the vehicle 100.

The powertrain includes one or more power distribution systems configured to transmit power from the power source 208 to one or more electric motors 212 in the vehicle 100. The power distribution system may include electrical interconnections 228 in the form of cables, wires, traces, wireless power transmission systems, etc., and/or combinations thereof. It is an aspect of the present disclosure that the vehicle 100 include one or more redundant electrical interconnections 232 of the power distribution system. The redundant electrical interconnections 232 can allow power to be distributed to one or more systems and/or subsystems of the vehicle 100 even in the event of a failure of an electrical interconnection portion of the vehicle 100 (e.g., due to an accident, mishap, tampering, or other harm to a particular electrical interconnection, etc.). In some embodiments, a user of a vehicle 100 may be alerted via a user interface associated with the vehicle 100 that a redundant electrical interconnection 232 is being used and/or damage has occurred to a particular area of the vehicle electrical system. In any event, the one or more redundant electrical interconnections 232 may be configured along completely different routes than the electrical interconnections 228 and/or include different modes of failure than the electrical interconnections 228 to, among other things, prevent a total interruption power distribution in the event of a failure.

In some embodiments, the power distribution system may include an energy recovery system 236. This energy recovery system 236, or kinetic energy recovery system, may be configured to recover energy produced by the movement of a vehicle 100. The recovered energy may be stored as electrical and/or mechanical energy. For instance, as a vehicle 100 travels or moves, a certain amount of energy is required to accelerate, maintain a speed, stop, or slow the vehicle 100. In any event, a moving vehicle has a certain amount of kinetic energy. When brakes are applied in a typical moving vehicle, most of the kinetic energy of the vehicle is lost as the generation of heat in the braking mechanism. In an energy recovery system 236, when a vehicle 100 brakes, at least a portion of the kinetic energy is converted into electrical and/or mechanical energy for storage. Mechanical energy may be stored as mechanical movement (e.g., in a flywheel, etc.) and electrical energy may be stored in batteries, capacitors, and/or some other electrical storage system. In some embodiments, electrical energy recovered may be stored in the power source 208. For example, the recovered electrical energy may be used to charge the power source 208 of the vehicle 100.

The vehicle 100 may include one or more safety systems. Vehicle safety systems can include a variety of mechanical and/or electrical components including, but in no way limited to, low impact or energy-absorbing bumpers 216A, 216B, crumple zones, reinforced body panels, reinforced frame components, impact bars, power source containment zones, safety glass, seatbelts, supplemental restraint systems, air bags, escape hatches, removable access panels, impact sensors, accelerometers, vision systems, radar systems, etc., and/or the like. In some embodiments, the one or more of the safety components may include a safety sensor or group of safety sensors associated with the one or more of the safety components. For example, a crumple zone may include one or more strain gages, impact sensors, pressure transducers, etc. These sensors may be configured to detect or determine whether a portion of the vehicle 100 has been subjected to a particular force, deformation, or other impact. Once detected, the information collected by the sensors may be transmitted or sent to one or more of a controller of the vehicle 100 (e.g., a safety controller, vehicle controller, etc.) or a communication device associated with the vehicle 100 (e.g., across a communication network, etc.).

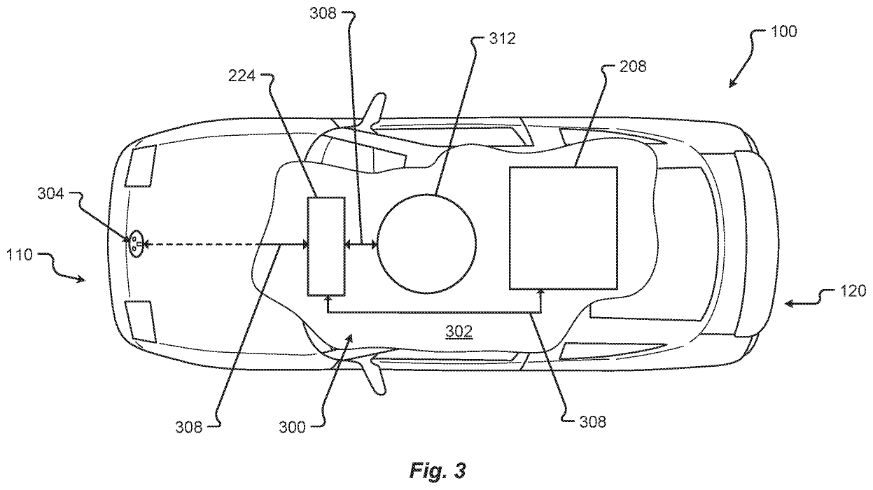

FIG. 3 shows a plan view of the vehicle 100 in accordance with embodiments of the present disclosure. In particular, FIG. 3 shows a broken section 302 of a charging system 300 for the vehicle 100. The charging system 300 may include a plug or receptacle 304 configured to receive power from an external power source (e.g., a source of power that is external to and/or separate from the vehicle 100, etc.). An example of an external power source may include the standard industrial, commercial, or residential power that is provided across power lines. Another example of an external power source may include a proprietary power system configured to provide power to the vehicle 100. In any event, power received at the plug/receptacle 304 may be transferred via at least one power transmission interconnection 308. Similar, if not identical, to the electrical interconnections 228 described above, the at least one power transmission interconnection 308 may be one or more cables, wires, traces, wireless power transmission systems, etc., and/or combinations thereof. Electrical energy in the form of charge can be transferred from the external power source to the charge controller 224. As provided above, the charge controller 224 may regulate the addition of charge to at least one power source 208 of the vehicle 100 (e.g., until the at least one power source 208 is full or at a capacity, etc.).

In some embodiments, the vehicle 100 may include an inductive charging system and inductive charger 312. The inductive charger 312 may be configured to receive electrical energy from an inductive power source external to the vehicle 100. In one embodiment, when the vehicle 100 and/or the inductive charger 312 is positioned over an inductive power source external to the vehicle 100, electrical energy can be transferred from the inductive power source to the vehicle 100. For example, the inductive charger 312 may receive the charge and transfer the charge via at least one power transmission interconnection 308 to the charge controller 324 and/or the power source 208 of the vehicle 100. The inductive charger 312 may be concealed in a portion of the vehicle 100 (e.g., at least partially protected by the frame 104, one or more body panels 108, a shroud, a shield, a protective cover, etc., and/or combinations thereof) and/or may be deployed from the vehicle 100. In some embodiments, the inductive charger 312 may be configured to receive charge only when the inductive charger 312 is deployed from the vehicle 100. In other embodiments, the inductive charger 312 may be configured to receive charge while concealed in the portion of the vehicle 100.

In addition to the mechanical components described herein, the vehicle 100 may include a number of user interface devices. The user interface devices receive and translate human input into a mechanical movement or electrical signal or stimulus. The human input may be one or more of motion (e.g., body movement, body part movement, in two-dimensional or three-dimensional space, etc.), voice, touch, and/or physical interaction with the components of the vehicle 100. In some embodiments, the human input may be configured to control one or more functions of the vehicle 100 and/or systems of the vehicle 100 described herein. User interfaces may include, but are in no way limited to, at least one graphical user interface of a display device, steering wheel or mechanism, transmission lever or button (e.g., including park, neutral, reverse, and/or drive positions, etc.), throttle control pedal or mechanism, brake control pedal or mechanism, power control switch, communications equipment, etc.

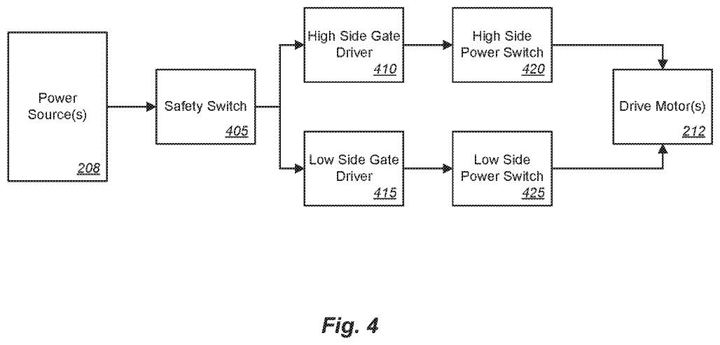

FIG. 4 is a block diagram illustrating additional details of an electrical system of the vehicle according to one embodiment of the present disclosure. As described above, the electrical system of the vehicle 100 can comprise one or more power sources 208 and one or more drive motors 212. Typically, and as known in the art, the power sources 208, such as a set of batteries, store and provide Direct Current (DC) while the drive motors 212 typically operate on Alternating Current (AC). Accordingly, the electrical system further comprises one or more power switch 420 and 425 which can each comprise one or more power transistors and which, as known in the art, convert the DC current of the power source 208 to AC power to operate the drive motors 212. As illustrated here, and as known in the art, the inverters can comprise a high side switch 420 and a low side switch 425 converting the DC power to AC power.

According to embodiments of the present disclosure, the electrical system of the vehicle 100 can further comprise an inverter safety switch 405. As will be described in greater detail below, the safety switch 405 can comprise fully redundant inverter safety switch off paths for inverter system fail safe/fail operational control of the switches 420 and 425. A safety switch 405 according to embodiments described herein can provide independent, redundant paths, for example, to high side and low side inverter driver gates 410 and 415, to shut off the switches 420 and 425 and electric motor output torque and ensure the safety state is achieved. An inverter safety switch 405 as will be described below can comprise a logic circuit including two AND gate and one two-way switch on each independent and redundant path. This design can be cost effective compared to current state of art designs using programable CPLDs or FPGAs and does not need to be programmed for each inverter. Additionally, such independent and redundant paths can eliminate the common cause or cascaded failures that can occur in prior safety switch designs.

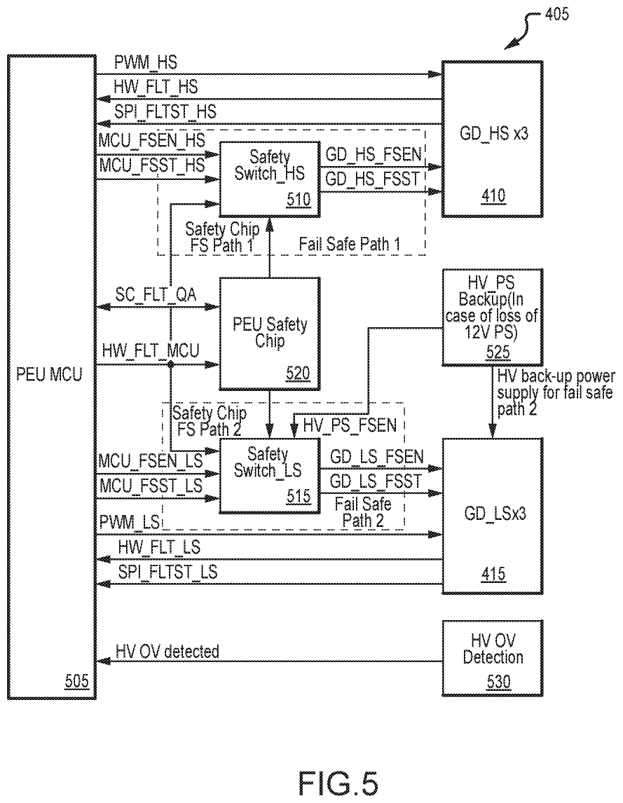

FIG. 5 is a block diagram illustrating redundant fail-safe paths of an inverter safety switch according to one embodiment of the present disclosure. More specifically, this example illustrates additional details of the inverter safety switch 405 introduced above. As can be seen here, the inverter safety switch circuit can comprise a microcontroller 505 receiving a plurality of input signals related to operation of a plurality of electrical power inverters. For example, the microcontroller 505 can receive input signals indicating hardware faults (HW_FLT_HS and HW_FLT_LS) and/or signals indicating test failures or faults (SPI_FLTST_HS and SPI_FLTST_LS) from the high side gate drivers 410 and low side gate drivers 415 for the inverters. The microcontroller 505 can also provide as output a plurality of control signals related to operation of the plurality of electrical power inverters. For example, the microprocessor can provide output signals to the gate drivers 410 and 415 indicating a power mode (PWM_HS and PWM_LS). The microcontroller 505 can also provide output signals including a failsafe enable signal (MCU_FSEN_HS and MCU_FSEN_LS) and a failsafe status signal (MCU_FSST_HS and MCU_FSST_LS).

The inverter safety switch circuit 405 can further comprise an inverter high side safety switch circuit 510 coupled with the microcontroller 505. The inverter high side safety switch circuit 510 can receive one or more control signals, e.g., MCU_FSEN_HS and MCU_FSST_HS as well as a signal indicating hardware faults (HW_FLT_MCU), from the microcontroller 505 and provide as output to the high side gate drivers 410 a plurality of control signals directed to operation of the high side power transistor in one of a plurality of states. For example, the output signals of the high side safety switch circuit 510 can comprise a failsafe enable signal (GD_HS_FSEN) and a failsafe status signal (GD_HS_FSST). The inverter safety switch circuit 405 can further comprise an inverter low side safety switch circuit 515 coupled with the microcontroller 505. Similarly, the inverter low side safety switch circuit 515 can receive one or more control signals, e.g., MCU_FSEN_LS, MCU_FSST_LS, and HW_FLT_MCU, from the microcontroller 505 and provide as output to the low side gate drivers 415 a plurality of control signals directed to operation of the low side power transistor in one of a plurality of states. For example, the output signals of the low side safety switch circuit 515 can comprise a failsafe enable signal (GD_LS_FSEN) and a failsafe status signal (GD_LS_FSST). In this arrangement, the high side safety switch circuit 510 can comprise a first fail-safe path between the microcontroller 505 and the high side gate drivers 410 of the high side power transistor, the low side safety switch circuit 515 can comprise a second fail-safe path between the microcontroller 505 and the low side gate drivers 415 of the low side power transistor, and the inverter low side safety switch circuit 515 can be redundant to and independent from the inverter high side safety switch circuit 510.

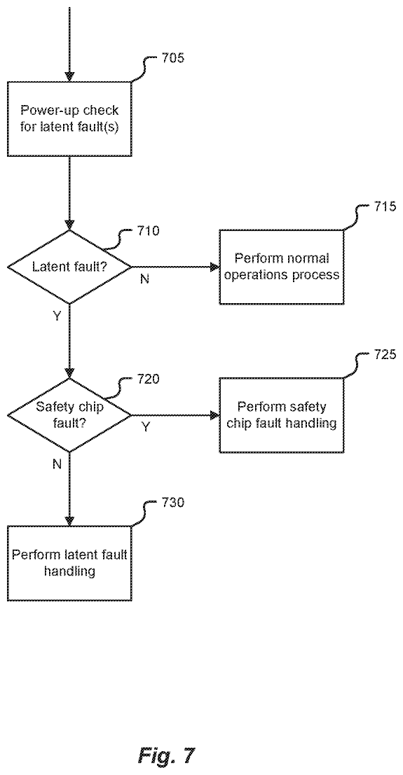

The inverter safety switch circuit 405 can further comprise a safety chip 520 coupled with each of the inverter high side safety switch circuit 510 and the inverter low side safety switch circuit 515. The safety chip 520 can receive as input from the microcontroller 505 safety information related to the high side power transistor and the low side power transistor such as an indication of one or more faults (HW_FLT_MCU) and exchange a quality assurance signal (SC_FLT_QA) with the microprocessor 505. The safety chip can provide as output control signals to each of the high side safety switch circuit 510 and the inverter low side safety switch circuit 515 based on the safety information. The plurality of control signals provided by each of the high side safety switch circuit 510 and the low side safety switch circuit 515 to the inverter gate drivers 410 and 415 can be further based on the control signals from the safety chip 520. Additional details of operation of the safety chip 520, high side safety switch circuit 510 and low side safety switch circuit 515 in various modes and upon the detection of various conditions will be described below with reference to FIGS. 7-10.

In some cases, and as illustrated here, the inverter safety switch circuit 405 can further comprise high voltage over voltage detector 530. The high voltage over voltage detector 530 can sense a voltage level of the invertors and provide a signal (HV OV detected) to the microcontroller 505. The microcontroller 505 can in turn, and based on this signal, provide output signals, e.g., status, enable, power mode, etc. as described above, to operate the safety switch to prevent damage to the inverters, drive motors, or other components of the vehicle. Additionally, or alternatively, the inverter safety switch circuit 405 can further comprise a high voltage power source backup 525, such as a battery, providing backup power to the low side gate drivers 415 in case of los of the main power supply and an enable signal to the low side safety switch circuit 515.

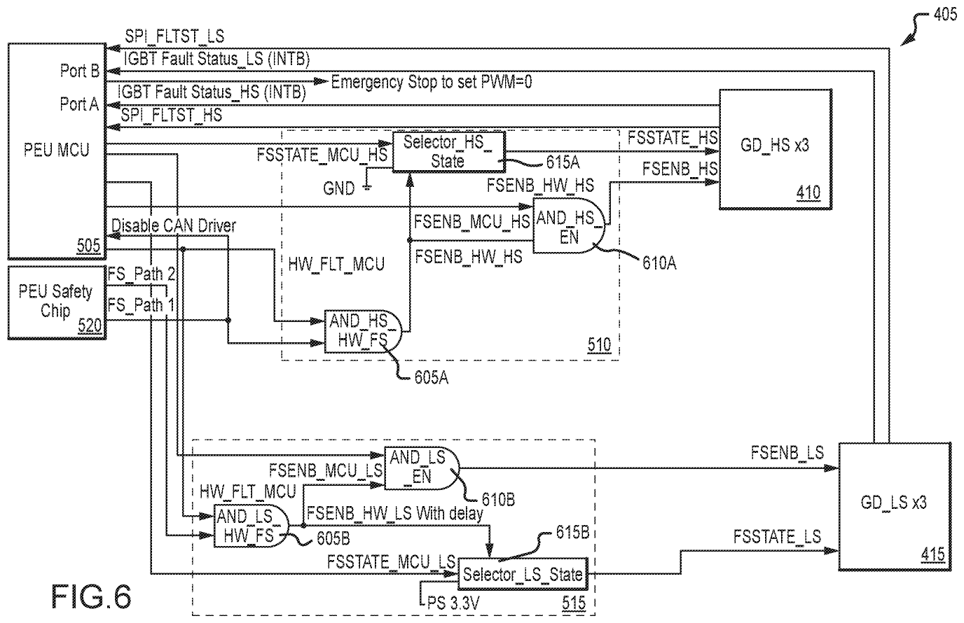

FIG. 6 is a schematic diagram of inverter safety switch circuits according to one embodiment of the present disclosure. Generally speaking, this example illustrates the microcontroller 505, safety chip 520 high side gate drivers 410 and low side gate drivers 415 as described above. Also, additional details of the high side safety switch circuit 510 and low side safety 515 are illustrated here. More specifically, both the inverter high side safety switch circuit 510 and the inverter low side safety switch circuit 515 can each comprise a first AND gate 605A and 605B receiving as input signals a safety information control signal from the safety chip 520 and a control signal from the microprocessor 505 indicating a presence or absence of a hardware fault and providing as output an enablement signal based on the input signals. Both the inverter high side safety switch circuit 510 and the inverter low side safety switch circuit 515 can each further comprise a second AND gate 610A and 610B receiving as input signals the enablement signal from the first AND gate 605A and 605B and an enablement signal from the microcontroller 505 and providing as output based on the input signals an enablement signal to the high side power transistor gate driver 410 or the low side power transistor gate driver 415. Both the inverter high side safety switch circuit 510 and the inverter low side safety switch circuit 515 can each further comprise a selector 615A and 615B receiving as input signals the enablement signal from the first AND gate 605A and 605B and state information from the microcontroller 505 and providing as output based on the input signals a state signal to the high side power transistor gate driver 410 or the low side power transistor gate driver 415. Operation of the elements of the high side and low side safety switch circuits 510 and 515 in various modes and in response to input signals indicating different states is described with reference to FIGS. 7-10.

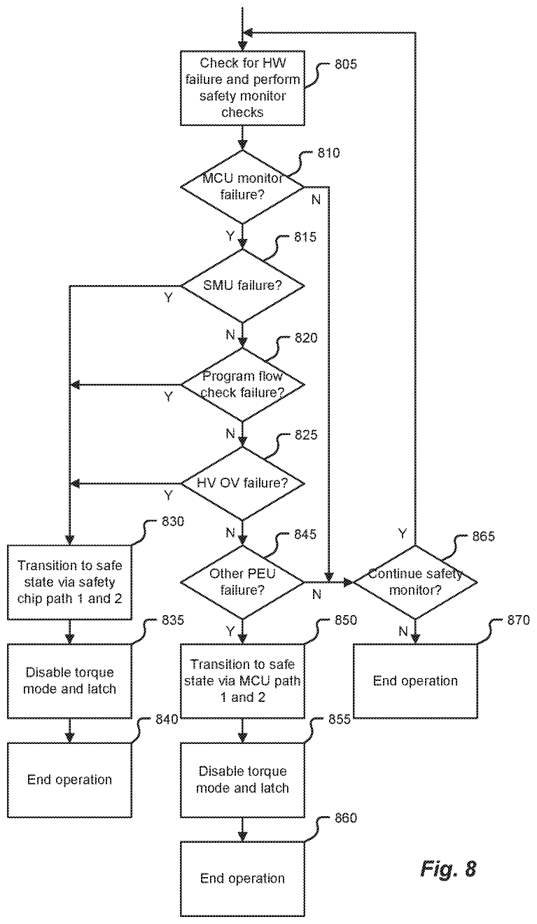

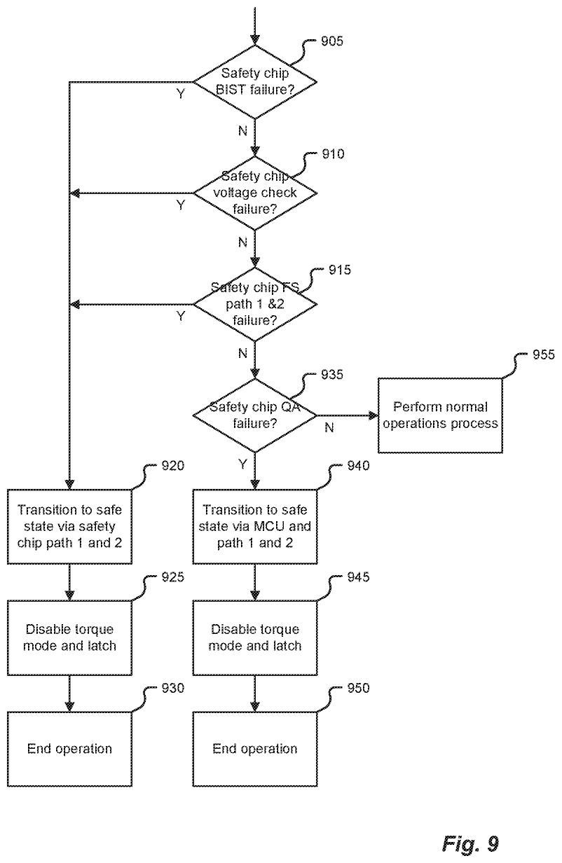

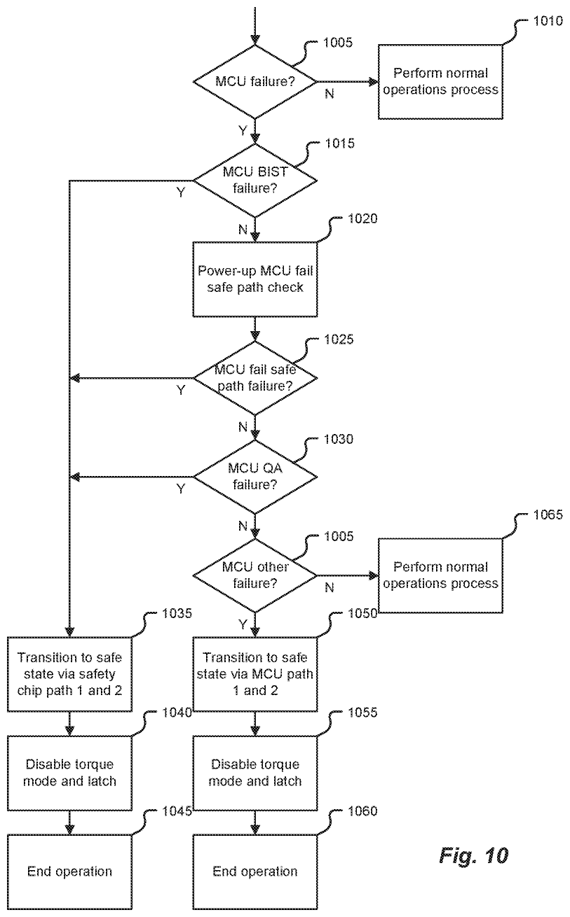

FIG. 7 is a flowchart illustrating an exemplary process for operating an inverter safety switch according to one embodiment of the present disclosure. As illustrated in this example, operating an inverter safety switch can comprise performing 705, by the safety switch, upon power up, a check for one or more latent faults. A determination 710 can be made, by the safety switch, based on the performing 705 of the check for one or more latent faults, whether a latent fault is detected. In response to determining 710 no latent fault is detected, the safety switch can perform 715 a normal operations process. Details of an exemplary normal operations process will be further described below with reference to FIG. 8. In response to determining 710 a latent fault is detected, the safety switch can make a further determination 720 as to whether the latent fault is a safety chip fault. In response to determining 720 the latent fault is a safety chip fault, the safety switch can perform 725 a safety chip fault handling process. Details of an exemplary safety chip fault handling process will be further described below with reference to FIG. 9. In response to determining 720 the latent fault is not a safety chip fault, the safety switch can perform 730 a latent fault handling process. Details of an exemplary latent fault handling process will be further described below with reference to FIG. 10.

FIG. 8 is a flowchart illustrating an exemplary process for normal operations of an inverter safety switch according to one embodiment of the present disclosure. As illustrated in this example, performing the normal operation process can comprise performing 805, by a power electronics unit of the inverter safety switch, one or more hardware failure checks and one or more safety monitor checks 805. Based on performing 808 the hardware failure checks, a number of determinations can be made as to presence of failures of different types. For example, a determination 810 can be made as to whether an MCU monitor failure has occurred. In response to determining 810 an MCU monitor failure has not occurred, a further determination 865 can be made as to whether to continue safety monitoring. In response to determining 865 safety monitoring should continue, e.g., vehicle operation continues, processing can return to performing 805 hardware failure and safety monitor checking. In response to determining 865 safety monitoring should not continue, e.g., vehicle operation has stopped, operations of the safety switch can end 870.

In response to determining 810 an MCU failure has occurred, a series of determinations can be made based on a type of failure detected. For example, a determination 815 can be made as to whether a safety monitoring unit failure has occurred, a determination 820 can be made as to whether a program flow check failure, and a determination 825 can be made as to whether an overvoltage failure can be made. In response to determining 815, 820, or 825 any of a safety monitoring unit failure, program flow check failure, or an overvoltage failure has occurred, the safety chip can transition 830 to a safe state via the first fail-safe path and the second fail-safe path, latch 835 an inverter torque mode disable state, and end 840 operations.

In response to determining 815, 820, or 825 none of a safety monitoring unit failure, program flow check failure, or an overvoltage failure has occurred, a further determination 845 can be made as to whether another power electronics unit failure has occurred. In response to determining another power electronics unit failure has not occurred, a further determination 865 can be made as to whether to continue safety monitoring. In response to determining 865 safety monitoring should continue, e.g., vehicle operation continues, processing can return to performing 805 hardware failure and safety monitor checking. In response to determining 865 safety monitoring should not continue, e.g., vehicle operation has stopped, operations of the safety switch can end 870. In response to determining 845 a power electronics unit failure has occurred, the microcontroller can transition 850 to a safe state via the first fail-safe path and the second fail-safe path, latch 855 an inverter torque mode disable state, and end 860 operations.

FIG. 9 is a flowchart illustrating an exemplary process for safety chip fault handling in an inverter safety switch according to one embodiment of the present disclosure. As illustrated in this example, performing the safety chip fault processing can comprise making a series of determinations as to a type of failure that may have occurred. For example, a determination 905 can be made as to whether a built-in safety test failure has occurred, a determination 910 can be made as to whether a voltage check failure has occurred, and a determination 915 can be made as to whether a first fail-safe path or second failsafe path failure has occurred. In response to determining 905, 910, or 915 the safety chip fault is any of a built-in safety test failure, a voltage check failure, or a first fail-safe path or second failsafe path failure, the safety chip can transition 920 to a safe state via the first fail-safe path and the second fail-safe path, latch 925 an inverter torque mode disable state, and end 930 operations.

In response to determining 905, 910, or 915 the safety chip fault is not a built-in safety test failure, a voltage check failure, or a first fail-safe path or second failsafe path failure, a further determination 935 can be made as to whether a safety chip quality assurance failure has occurred. In response to determining 935 the safety chip fault is a quality assurance failure, the microcontroller can transition 940 to a safe state via the first fail-safe path and the second fail-safe path, latch 945 an inverter torque mode disable state, and end 950 operations. In response to determining 935 the safety chip fault is not a quality assurance failure, processing can return to performing 955 normal operations as described above with reference to FIG. 8.

FIG. 10 is a flowchart illustrating an exemplary process for latent fault handling in an inverter safety switch according to one embodiment of the present disclosure. As illustrated in this example, performing the latent fault processing can comprise determining 1005 whether the latent fault is a microcontroller failure. In response to determining 1005 the latent fault is not a microcontroller failure, processing can return to performing 1010 normal operations as described above with reference to FIG. 8. In response to determining 1010 the latent fault is a microcontroller failure, a further determination 1015 can be made as to whether the microcontroller failure is a built-in safety test failure. In response to determining 1015 the latent fault is a microcontroller built-in safety test failure, the safety chip can transition 1035 to a safe state via the first fail-safe path and the second fail-safe path, latch 1040 an inverter torque mode disable state, and end 1045 operations.

In response to determining 1015 the latent fault is not a microcontroller built-in safety test failure, the microcontroller can perform 1020 a power-up fail-safe path check and make a series of determinations as to the type of failure that has occurred. For example, a determination 1025 can be made as to whether the latent fault is a microcontroller fail-safe path failure has occurred and a determination 1030 can be made as to a quality assurance failure has occurred. In response to determining 1025 or 1030 the latent fault is either a microcontroller fail-safe path failure or a quality assurance failure, the safety chip can transition 1035 to a safe state via the first fail-safe path and the second fail-safe path, latch 1040 an inverter torque mode disable state, and end 1045 operations.

In response to determining 1025 or 1030 the latent fault is not a microcontroller fail-safe path failure or a quality assurance failure, a further determination can be made as to whether another microcontroller fault has occurred. In response to determining the latent fault is another microcontroller fault, the microcontroller can transition 1050 to a safe state via the first fail-safe path and the second fail-safe path, latch 1055 an inverter torque mode disable state, and end 1060 operations. In response to determining the latent fault is another microcontroller fault, processing can return to performing 1010 normal operations as described above with reference to FIG. 8.

Any of the steps, functions, and operations discussed herein can be performed continuously and automatically.

The exemplary systems and methods of this disclosure have been described in relation to vehicle systems and electric vehicles. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, sub-combinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

Embodiments include an inverter safety switch circuit comprising: a microcontroller receiving a plurality of input signals related to operation of a plurality of electrical power inverters and providing as output a plurality of control signals related to operation of the plurality of electrical power inverters, the plurality of electrical power inverters comprising a high side power transistor and a low side power transistor; an inverter high side safety switch circuit coupled with the microcontroller, the inverter high side safety switch circuit receiving one or more control signals from the microcontroller and providing as output a plurality of control signals directed to operation of the high side power transistor in one of a plurality of states, wherein the high side safety switch circuit comprises a first fail-safe path between the microcontroller and the high side power transistor; and an inverter low side safety switch circuit coupled with the microcontroller, the inverter low side safety switch circuit receiving one or more control signals from the microcontroller and providing as output a plurality of control signals directed to operation of the low side power transistor in one of a plurality of states, wherein the low side safety switch circuit comprises a second fail-safe path between the microcontroller and the low side power transistor, and wherein the inverter low side safety switch circuit is redundant to and independent from the inverter high side safety switch circuit.

Aspects of the above inverter safety switch circuit include a safety chip coupled with each of the inverter high side safety switch circuit and the inverter low side safety switch circuit, the safety chip receiving as input from the microcontroller safety information related to the high side power transistor and the low side power transistor and providing as output control signals to each of the high side safety switch circuit and the inverter low side safety switch circuit based on the safety information, wherein the plurality of control signals provided by each of the high side safety switch circuit and the low side safety switch circuit are further based on the control signals from the safety chip.

Aspects of the above inverter safety switch circuit include wherein the inverter high side safety switch circuit and the inverter low side safety switch circuit each comprise: a first AND gate receiving as input signals a safety information control signal from the safety chip and a control signal indicating a presence or absence of a hardware fault from the microcontroller and providing as output an enablement signal based on the input signals; a second AND gate receiving as input signals the enablement signal from the first AND gate and an enablement signal from the microcontroller and providing as output an enablement signal to the high side power transistor or the low side power transistor based on the input signals; and a selector receiving as input signals the enablement signal from the first AND gate and state information from the microcontroller and providing as output a state signal to the high side power transistor or the low side power transistor based on the input signals.

Aspects of the above inverter safety switch circuit include wherein the selector provides the state signal indicating one of a plurality of states for the high side power transistor or the low side power transistor by: performing, upon power up of the safety switch, a check for one or more latent faults; determining, based on the performing of the check for one or more latent faults, whether a latent fault is detected; in response to determining no latent fault is detected, performing a normal operations process; in response to determining a latent fault is detected, further determining whether the latent fault is a safety chip fault; in response to determining the latent fault is a safety chip fault, performing a safety chip fault handling process; and in response to determining the latent fault is not a safety chip fault, performing a latent fault handling process.

Aspects of the above inverter safety switch circuit include wherein performing the normal operation process further comprises: performing, by a power electronics unit of the inverter safety switch, one or more hardware failure and one or more safety monitor checks; in response to detecting a safety monitoring unit failure, program flow check failure, or an overvoltage failure, transitioning, by the safety chip, to a safe state via the first fail-safe path and the second fail-safe path, latching an inverter torque mode disable state, and ending operations; and in response to detecting a power electronics unit failure, transitioning, by the microcontroller, to a safe state via the first fail-safe path and the second fail-safe path, latching an inverter torque mode disable state, and ending operations.

Aspects of the above inverter safety switch circuit include wherein performing the safety chip fault processing further comprises: in response to determining the safety chip fault is a built-in safety test failure, a voltage check failure, or a first fail-safe path or second failsafe path failure, transitioning, by the safety chip, to a safe state via the first fail-safe path and the second fail-safe path, latching an inverter torque mode disable state, and ending operations; and in response to determining the safety chip fault is a quality assurance failure, transitioning, by the microcontroller, to a safe state via the first fail-safe path and the second fail-safe path, latching an inverter torque mode disable state, and ending operations.

Aspects of the above inverter safety switch circuit include wherein performing the latent fault processing further comprises: in response to determining the latent fault is a microcontroller built-in safety test failure, transitioning, by the safety chip, to a safe state via the first fail-safe path and the second fail-safe path, latching an inverter torque mode disable state, and ending operations; in response to determining the latent fault is not a microcontroller built-in safety test failure, performing, by the microcontroller, a power-up fail-safe path check and determining whether the latent fault is a microcontroller fail-safe path failure or a quality assurance failure; in response to determining the latent fault is a microcontroller fail-safe path failure or a quality assurance failure, transitioning, by the safety chip, to a safe state via the first fail-safe path and the second fail-safe path, latching an inverter torque mode disable state, and ending operations; and in response to determining the latent fault is other than a microcontroller fail-safe path failure or a quality assurance failure, transitioning, by the microcontroller, to a safe state via the first fail-safe path and the second fail-safe path, latching an inverter torque mode disable state, and ending operations.

Embodiments include an electric vehicle comprising: one or more electrical drive motors; a plurality of electrical power inverters providing electrical power to the one or more electrical drive motors, the plurality of electrical power inverters comprising at least one high side power transistor and at least one low side power transistor; a plurality of gate drivers coupled with and controlling operation of the plurality of electrical power inverters, the plurality of gate drivers comprising at least one high side gate driver coupled with and controlling operation of the high side power transistor and at least one low side gate driver coupled with and controlling operation of the low side power transistor; an inverter safety switch circuit coupled with each of the plurality of gate drivers, the inverter safety switch further comprising: a microcontroller receiving a plurality of input signals related to operation of a plurality of electrical power inverters and providing as output a plurality of control signals related to operation of the plurality of electrical power inverters; an inverter high side safety switch circuit coupled with the microcontroller, the inverter high side safety switch circuit receiving one or more control signals from the microcontroller and providing as output to the high side gate driver a plurality of control signals directed to operation of the high side power transistor in one of a plurality of states, wherein the high side safety switch circuit comprises a first fail safe path between the microcontroller, and wherein the high side gate driver controls operation of the high side power transistor based on the control signals from the high side safety switch circuit; and an inverter low side safety switch circuit coupled with the microcontroller, the inverter low side safety switch circuit receiving one or more control signals from the microcontroller and providing as output to the low side gate drivers a plurality of control signals related to operation of the low side power transistor in one of a plurality of states, wherein the low side safety switch circuit comprises a second fail safe path between the microcontroller and the low side power transistor, wherein the low side gate driver controls operation of the low side power transistor based on the control signals from the low side safety switch circuit, and wherein the inverter low side safety switch circuit is redundant to and independent from the inverter high side safety switch circuit.

Aspects of the above electric vehicle include a safety chip coupled with each of the inverter high side safety switch circuit and the inverter low side safety switch circuit, the safety chip receiving as input from the microcontroller safety information related to the high side power transistor and the low side power transistor and providing as output control signals to each of the high side safety switch circuit and the inverter low side safety switch circuit based on the safety information, wherein the plurality of control signals provided by each of the high side safety switch circuit and the low side safety switch circuit are further based on the control signals from the safety chip.

Aspects of the above electric vehicle include wherein the inverter high side safety switch circuit and the inverter low side safety switch circuit each comprise: a first AND gate receiving as input signals a safety information control signal from the safety chip and a control signal indicating a presence or absence of a hardware fault from the microcontroller and providing as output an enablement signal based on the input signals; a second AND gate receiving as input signals the enablement signal from the first AND gate and an enablement signal from the microcontroller and providing as output an enablement signal to the high side power transistor or the low side power transistor based on the input signals; and a selector receiving as input signals the enablement signal from the first AND gate and state information from the microcontroller and providing as output a state signal to the high side power transistor or the low side power transistor based on the input signals.

Aspects of the above electric vehicle include wherein the selector provides the state signal indicating one of a plurality of states for the high side power transistor or the low side power transistor by: performing, upon power up of the safety switch, a check for one or more latent faults; determining, based on the performing of the check for one or more latent faults, whether a latent fault is detected; in response to determining no latent fault is detected, performing a normal operations process; in response to determining a latent fault is detected, further determining whether the latent fault is a safety chip fault; in response to determining the latent fault is a safety chip fault, performing a safety chip fault handling process; and in response to determining the latent fault is not a safety chip fault, performing a latent fault handling process.

Aspects of the above electric vehicle include wherein performing the normal operation process further comprises: performing, by a power electronics unit of the inverter safety switch, one or more hardware failure and one or more safety monitor checks; in response to detecting a safety monitoring unit failure, program flow check failure, or an overvoltage failure, transitioning, by the safety chip, to a safe state via the first fail-safe path and the second fail-safe path, latching an inverter torque mode disable state, and ending operations; and in response to detecting a power electronics unit failure, transitioning, by the microcontroller, to a safe state via the first fail-safe path and the second fail-safe path, latching an inverter torque mode disable state, and ending operations.

Aspects of the above electric vehicle include wherein performing the safety chip fault processing further comprises: in response to determining the safety chip fault is a built-in safety test failure, a voltage check failure, or a first fail-safe path or second failsafe path failure, transitioning, by the safety chip, to a safe state via the first fail-safe path and the second fail-safe path, latching an inverter torque mode disable state, and ending operations; and in response to determining the safety chip fault is a quality assurance failure, transitioning, by the microcontroller, to a safe state via the first fail-safe path and the second fail-safe path, latching an inverter torque mode disable state, and ending operations.

Aspects of the above electric vehicle include wherein performing the latent fault processing further comprises: in response to determining the latent fault is a microcontroller built-in safety test failure, transitioning, by the safety chip, to a safe state via the first fail-safe path and the second fail-safe path, latching an inverter torque mode disable state, and ending operations; in response to determining the latent fault is not a microcontroller built-in safety test failure, performing, by the microcontroller, a power-up fail-safe path check and determining whether the latent fault is a microcontroller fail-safe path failure or a quality assurance failure; in response to determining the latent fault is a microcontroller fail-safe path failure or a quality assurance failure, transitioning, by the safety chip, to a safe state via the first fail-safe path and the second fail-safe path, latching an inverter torque mode disable state, and ending operations; and in response to determining the latent fault is other than a microcontroller fail-safe path failure or a quality assurance failure, transitioning, by the microcontroller, to a safe state via the first fail-safe path and the second fail-safe path, latching an inverter torque mode disable state, and ending operations.

Embodiments include a method for operating an inverter safety switch, the method comprising: performing, by the safety switch, upon power up, a check for one or more latent faults; determining, by the safety switch, based on the performing of the check for one or more latent faults, whether a latent fault is detected; in response to determining no latent fault is detected, performing, by the safety switch, a normal operations process; in response to determining a latent fault is detected, further determining, by the safety switch, whether the latent fault is a safety chip fault; in response to determining the latent fault is a safety chip fault, performing, by the safety switch, a safety chip fault handling process; and in response to determining the latent fault is not a safety chip fault, performing, by the safety switch, a latent fault handling process.

Aspects of the above method include wherein performing the normal operation process further comprises: performing, by a power electronics unit of the inverter safety switch, one or more hardware failure and one or more safety monitor checks; in response to detecting a safety monitoring unit failure, program flow check failure, or an overvoltage failure, transitioning, by the safety chip, to a safe state via the first fail-safe path and the second fail-safe path, latching an inverter torque mode disable state, and ending operations; and in response to detecting a power electronics unit failure, transitioning, by the microcontroller, to a safe state via the first fail-safe path and the second fail-safe path, latching an inverter torque mode disable state, and ending operations.

Aspects of the above method include wherein performing the safety chip fault processing further comprises: in response to determining the safety chip fault is a built-in safety test failure, a voltage check failure, or a first fail-safe path or second failsafe path failure, transitioning, by the safety chip, to a safe state via the first fail-safe path and the second fail-safe path, latching an inverter torque mode disable state, and ending operations; and in response to determining the safety chip fault is a quality assurance failure, transitioning, by the microcontroller, to a safe state via the first fail-safe path and the second fail-safe path, latching an inverter torque mode disable state, and ending operations.

Aspects of the above method include wherein performing the latent fault processing further comprises: in response to determining the latent fault is a microcontroller built-in safety test failure, transitioning, by the safety chip, to a safe state via the first fail-safe path and the second fail-safe path, latching an inverter torque mode disable state, and ending operations; and in response to determining the latent fault is not a microcontroller built-in safety test failure, performing, by the microcontroller, a power-up fail-safe path check and determining whether the latent fault is a microcontroller fail-safe path failure or a quality assurance failure.

Aspects of the above method include in response to determining the latent fault is a microcontroller fail-safe path failure or a quality assurance failure, transitioning, by the safety chip, to a safe state via the first fail-safe path and the second fail-safe path, latching an inverter torque mode disable state, and ending operations.

Aspects of the above method include in response to determining the latent fault is other than a microcontroller fail-safe path failure or a quality assurance failure, transitioning, by the microcontroller, to a safe state via the first fail-safe path and the second fail-safe path, latching an inverter torque mode disable state, and ending operations.

Any one or more of the aspects/embodiments as substantially disclosed herein.

Any one or more of the aspects/embodiments as substantially disclosed herein optionally in combination with any one or more other aspects/embodiments as substantially disclosed herein.

One or means adapted to perform any one or more of the above aspects/embodiments as substantially disclosed herein.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “electric vehicle” (EV), also referred to herein as an electric drive vehicle, may use one or more electric motors or traction motors for propulsion. An electric vehicle may be powered through a collector system by electricity from off-vehicle sources, or may be self-contained with a battery or generator to convert fuel to electricity. An electric vehicle generally includes a rechargeable electricity storage system (RESS) (also called Full Electric Vehicles (FEV)). Power storage methods may include: chemical energy stored on the vehicle in on-board batteries (e.g., battery electric vehicle or BEV), on board kinetic energy storage (e.g., flywheels), and/or static energy (e.g., by on-board double-layer capacitors). Batteries, electric double-layer capacitors, and flywheel energy storage may be forms of rechargeable on-board electrical storage.

The term “hybrid electric vehicle” refers to a vehicle that may combine a conventional (usually fossil fuel-powered) powertrain with some form of electric propulsion. Most hybrid electric vehicles combine a conventional internal combustion engine (ICE) propulsion system with an electric propulsion system (hybrid vehicle drivetrain). In parallel hybrids, the ICE and the electric motor are both connected to the mechanical transmission and can simultaneously transmit power to drive the wheels, usually through a conventional transmission. In series hybrids, only the electric motor drives the drivetrain, and a smaller ICE works as a generator to power the electric motor or to recharge the batteries. Power-split hybrids combine series and parallel characteristics. A full hybrid, sometimes also called a strong hybrid, is a vehicle that can run on just the engine, just the batteries, or a combination of both. A mid hybrid is a vehicle that cannot be driven solely on its electric motor, because the electric motor does not have enough power to propel the vehicle on its own.

The term “rechargeable electric vehicle” or “REV” refers to a vehicle with on board rechargeable energy storage, including electric vehicles and hybrid electric vehicles.

What is claimed is:

1. An inverter safety switch comprising:
a microcontroller receiving a plurality of input signals related to operation of a power inverter and providing as output a plurality of control signals related to operation of a plurality of power transistors of the power inverter, the plurality of power transistors comprising a high side power transistor and a low side power transistor;
an inverter high side safety switch circuit coupled with the microcontroller, the inverter high side safety switch circuit receiving one or more control signals from the microcontroller and providing as output a plurality of control signals directed to operation of the high side power transistor in one of a plurality of states, wherein the high side safety switch circuit comprises a first fail-safe path between the microcontroller and the high side power transistor; and
an inverter low side safety switch circuit coupled with the microcontroller, the inverter low side safety switch circuit receiving one or more control signals from the microcontroller and providing as output a plurality of control signals directed to operation of the low side power transistor in one of a plurality of states, wherein the low side safety switch circuit comprises a second fail-safe path between the microcontroller and the low side power transistor, and wherein the inverter low side safety switch is redundant to and independent from the inverter high side safety switch circuit.

2. The inverter safety switch of claim 1, further comprising a safety chip coupled with each of the inverter high side safety switch circuit and the inverter low side safety switch circuit, the safety chip receiving as input from the microcontroller safety information related to the high side power transistor and the low side power transistor and providing as output control signals to each of the high side safety switch circuit and the inverter low side safety switch circuit based on the safety information, wherein the plurality of control signals provided by each of the high side safety switch circuit and the low side safety switch circuit are further based on the control signals from the safety chip.

3. The inverter safety switch of claim 2, wherein the inverter high side safety switch circuit and the inverter low side safety switch circuit each comprise:
a first AND gate receiving as input signals a safety information control signal from the safety chip and a control signal indicating a presence or absence of a hardware fault from the microcontroller and providing as output an enablement signal based on the input signals;
a second AND gate receiving as input signals the enablement signal from the first AND gate and an enablement signal from the microcontroller and providing as output an enablement signal to the high side power transistor or the low side power transistor based on the input signals; and
a selector receiving as input signals the enablement signal from the first AND gate and state information from the microcontroller and providing as output a state signal to the high side power transistor or the low side power transistor based on the input signals.

4. The inverter safety switch of claim 3, wherein the selector provides the state signal indicating one of a plurality of states for the high side power transistor or the low side power transistor by:
performing, upon power up of the safety switch, a check for one or more latent faults;
determining, based on the performing of the check for one or more latent faults, whether a latent fault is detected;
in response to determining no latent fault is detected, performing a normal operations process;
in response to determining a latent fault is detected, further determining whether the latent fault is a safety chip fault;
in response to determining the latent fault is a safety chip fault, performing a safety chip fault handling process; and
in response to determining the latent fault is not a safety chip fault, performing a latent fault handling process.

5. The inverter safety switch of claim 4, wherein performing the normal operation process further comprises:
performing, by a power electronics unit of the inverter safety switch, one or more hardware failure and one or more safety monitor checks;
in response to detecting a safety monitoring unit failure, program flow check failure, or an overvoltage failure, transitioning, by the safety chip, to a safe state via the first fail-safe path and the second fail-safe path, latching an inverter torque mode disable state, and ending operations; and
in response to detecting a power electronics unit failure, transitioning, by the microcontroller, to a safe state via the first fail-safe path and the second fail-safe path, latching an inverter torque mode disable state, and ending operations.

6. The inverter safety switch of claim 4, wherein performing the safety chip fault processing further comprises:
in response to determining the safety chip fault is a built-in safety test failure, a voltage check failure, or a first fail-safe path or second failsafe path failure, transitioning, by the safety chip, to a safe state via the first fail-safe path and the second fail-safe path, latching an inverter torque mode disable state, and ending operations; and
in response to determining the safety chip fault is a quality assurance failure, transitioning, by the microcontroller, to a safe state via the first fail-safe path and the second fail-safe path, latching an inverter torque mode disable state, and ending operations.

7. The inverter safety switch of claim 4, wherein performing the latent fault processing further comprises:
in response to determining the latent fault is a microcontroller built-in safety test failure, transitioning, by the safety chip, to a safe state via the first fail-safe path and the second fail-safe path, latching an inverter torque mode disable state, and ending operations;
in response to determining the latent fault is not a microcontroller built-in safety test failure, performing, by the microcontroller, a power-up fail-safe path check and determining whether the latent fault is a microcontroller fail-safe path failure or a quality assurance failure;
in response to determining the latent fault is a microcontroller fail-safe path failure or a quality assurance failure, transitioning, by the safety chip, to a safe state via the first fail-safe path and the second fail-safe path, latching an inverter torque mode disable state, and ending operations; and
in response to determining the latent fault is other than a microcontroller fail-safe path failure or a quality assurance failure, transitioning, by the microcontroller, to a safe state via the first fail-safe path and the second fail-safe path, latching an inverter torque mode disable state, and ending operations.

8. An electric vehicle comprising:
one or more electrical drive motors;
a plurality of electrical power inverters providing electrical power to the one or more electrical drive motors, the plurality of electrical power inverters comprising at least one set of high side power transistors and at least one set of low side power transistors;
a plurality of gate drivers coupled with and controlling operation of the plurality of electrical power inverters, the plurality of gate drivers comprising at least one high side gate driver coupled with and controlling operation of the high side power transistor and at least one low side gate driver coupled with and controlling operation of the low side power transistor;
an inverter safety switch circuit coupled with each of the plurality of gate drivers, the inverter safety switch further comprising:
a microcontroller receiving a plurality of input signals related to operation of a plurality of electrical power inverters and providing as output a plurality of control signals related to operation of the plurality of electrical power inverters;
an inverter high side safety switch circuit coupled with the microcontroller, the inverter high side safety switch circuit receiving one or more control signals from the microcontroller and providing as output to the high side gate driver a plurality of control signals directed to operation of the high side power transistor in one of a plurality of states, wherein the high side safety switch circuit comprises a first fail safe path between the microcontroller, and wherein the high side gate driver controls operation of the high side power transistor based on the control signals from the high side safety switch circuit; and
an inverter low side safety switch circuit coupled with the microcontroller, the inverter low side safety switch circuit receiving one or more control signals from the microcontroller and providing as output to the low side gate drivers a plurality of control signals related to operation of the low side power transistor in one of a plurality of states, wherein the low side safety switch circuit comprises a second fail safe path between the microcontroller and the low side power transistor, wherein the low side gate driver controls operation of the low side power transistor based on the control signals from the low side safety switch circuit, and wherein the inverter low side safety switch circuit is redundant to and independent from the inverter high side safety switch circuit.

9. The electric vehicle of claim 8, further comprising a safety chip coupled with each of the inverter high side safety switch circuit and the inverter low side safety switch circuit, the safety chip receiving as input from the microcontroller safety information related to the high side power transistor and the low side power transistor and providing as output control signals to each of the high side safety switch circuit and the inverter low side safety switch circuit based on the safety information, wherein the plurality of control signals provided by each of the high side safety switch circuit and the low side safety switch circuit are further based on the control signals from the safety chip.

10. The electric vehicle of claim 9, wherein the inverter high side safety switch circuit and the inverter low side safety switch circuit each comprise:
a first AND gate receiving as input signals a safety information control signal from the safety chip and a control signal indicating a presence or absence of a hardware fault from the microcontroller and providing as output an enablement signal based on the input signals;
a second AND gate receiving as input signals the enablement signal from the first AND gate and an enablement signal from the microcontroller and providing as output an enablement signal to the high side power transistor or the low side power transistor based on the input signals; and
a selector receiving as input signals the enablement signal from the first AND gate and state information from the microcontroller and providing as output a state signal to the high side power transistor or the low side power transistor based on the input signals.

11. The electric vehicle of claim 10, wherein the selector provides the state signal indicating one of a plurality of states for the high side power transistor or the low side power transistor by:
performing, upon power up of the safety switch, a check for one or more latent faults;
determining, based on the performing of the check for one or more latent faults, whether a latent fault is detected;
in response to determining no latent fault is detected, performing a normal operations process;
in response to determining a latent fault is detected, further determining whether the latent fault is a safety chip fault;
in response to determining the latent fault is a safety chip fault, performing a safety chip fault handling process; and
in response to determining the latent fault is not a safety chip fault, performing a latent fault handling process.

12. The electric vehicle of claim 11, wherein performing the normal operation process further comprises:
performing, by a power electronics unit of the inverter safety switch, one or more hardware failure and one or more safety monitor checks;
in response to detecting a safety monitoring unit failure, program flow check failure, or an overvoltage failure, transitioning, by the safety chip, to a safe state via the first fail-safe path and the second fail-safe path, latching an inverter torque mode disable state, and ending operations; and
in response to detecting a power electronics unit failure, transitioning, by the microcontroller, to a safe state via the first fail-safe path and the second fail-safe path, latching an inverter torque mode disable state, and ending operations.

13. The electric vehicle of claim 11, wherein performing the safety chip fault processing further comprises:
in response to determining the safety chip fault is a built-in safety test failure, a voltage check failure, or a first fail-safe path or second failsafe path failure, transitioning, by the safety chip, to a safe state via the first fail-safe path and the second fail-safe path, latching an inverter torque mode disable state, and ending operations; and
in response to determining the safety chip fault is a quality assurance failure, transitioning, by the microcontroller, to a safe state via the first fail-safe path and the second fail-safe path, latching an inverter torque mode disable state, and ending operations.

14. The electric vehicle of claim 11, wherein performing the latent fault processing further comprises:
in response to determining the latent fault is a microcontroller built-in safety test failure, transitioning, by the safety chip, to a safe state via the first fail-safe path and the second fail-safe path, latching an inverter torque mode disable state, and ending operations;
in response to determining the latent fault is not a microcontroller built-in safety test failure, performing, by the microcontroller, a power-up fail-safe path check and determining whether the latent fault is a microcontroller fail-safe path failure or a quality assurance failure;
in response to determining the latent fault is a microcontroller fail-safe path failure or a quality assurance failure, transitioning, by the safety chip, to a safe state via the first fail-safe path and the second fail-safe path, latching an inverter torque mode disable state, and ending operations; and
in response to determining the latent fault is other than a microcontroller fail-safe path failure or a quality assurance failure, transitioning, by the microcontroller, to a safe state via the first fail-safe path and the second fail-safe path, latching an inverter torque mode disable state, and ending operations.

15. A method for operating an inverter safety switch, the method comprising:
performing, by the safety switch, upon power up, a check for one or more latent faults;
determining, by the safety switch, based on the performing of the check for one or more latent faults, whether a latent fault is detected;
in response to determining no latent fault is detected, performing, by the safety switch, a normal operations process;
in response to determining a latent fault is detected, further determining, by the safety switch, whether the latent fault is a safety chip fault;
in response to determining the latent fault is a safety chip fault, performing, by the safety switch, a safety chip fault handling process; and
in response to determining the latent fault is not a safety chip fault, performing, by the safety switch, a latent fault handling process.

16. The method of claim 15, wherein performing the normal operation process further comprises:
performing, by a power electronics unit of the inverter safety switch, one or more hardware failure and one or more safety monitor checks;
in response to detecting a safety monitoring unit failure, program flow check failure, or an overvoltage failure, transitioning, by the safety chip, to a safe state via the first fail-safe path and the second fail-safe path, latching an inverter torque mode disable state, and ending operations; and
in response to detecting a power electronics unit failure, transitioning, by the microcontroller, to a safe state via the first fail-safe path and the second fail-safe path, latching an inverter torque mode disable state, and ending operations.

17. The method of claim 15, wherein performing the safety chip fault processing further comprises:
in response to determining the safety chip fault is a built-in safety test failure, a voltage check failure, or a first fail-safe path or second failsafe path failure, transitioning, by the safety chip, to a safe state via the first fail-safe path and the second fail-safe path, latching an inverter torque mode disable state, and ending operations; and
in response to determining the safety chip fault is a quality assurance failure, transitioning, by the microcontroller, to a safe state via the first fail-safe path and the second fail-safe path, latching an inverter torque mode disable state, and ending operations.

18. The method of claim 15, wherein performing the latent fault processing further comprises:
in response to determining the latent fault is a microcontroller built-in safety test failure, transitioning, by the safety chip, to a safe state via the first fail-safe path and the second fail-safe path, latching an inverter torque mode disable state, and ending operations; and
in response to determining the latent fault is not a microcontroller built-in safety test failure, performing, by the microcontroller, a power-up fail-safe path check and determining whether the latent fault is a microcontroller fail-safe path failure or a quality assurance failure.

19. The method of claim 18, further comprising in response to determining the latent fault is a microcontroller fail-safe path failure or a quality assurance failure, transitioning, by the safety chip, to a safe state via the first fail-safe path and the second fail-safe path, latching an inverter torque mode disable state, and ending operations.

20. The method of claim 19, further comprising in response to determining the latent fault is other than a microcontroller fail-safe path failure or a quality assurance failure, transitioning, by the microcontroller, to a safe state via the first fail-safe path and the second fail-safe path, latching an inverter torque mode disable state, and ending operations.
